(19) United States
(12) Patent Application Publication
(10) Pub. No.: US 2007/0031580 A1
(43) Pub. Date: Feb. 8, 2007

(54) Solid co-crystallized monoglyceride and fatty acid lactylate emulsifier and starch-complexing agent and method of producing same

(76) Inventors: Troy Boutte, Overland Park, KS (US); Lawrence Skogerson, Mission Hills, KS (US)

Correspondence Address: HOVEY WILLIAMS LLP, 2405 GRAND BLVD., SUITE 400, KANSAS CITY, MO, 64108, US

(21) Appl. No.: 11/200,764

(22) Filed: Aug. 10, 2005

(51) Int. Cl. A21D 2/16

(52) U.S. Cl. 426/653

(57) ABSTRACT

A solid co-crystallized monoglyceride and fatty acid lactylate emulsifier and starch-complexing agent is provided in which a saturated monoglyceride and a fatty acid lactylate salt are completed to produce a homogenous composition, and then cooled and solidified under conditions forming discrete co-crystallized stable emulsifier particles having a differential scanning calorimeter (DSC) defined melting point of no more than about 60° C. Saturated monoglycerides are functional only after the temperature thereof has been increased to their Krafft temperature of about 60° C. Previously, it has been necessary to pre-hydrate monoglycerides to make them functional when added to bread doughs and batter formulations at conventional commercial baking temperatures of about 70° F. to about 80° F. The co-crystallized monoglyceride and fatty acid lactylate combination of this invention is fully functional without pre-hydration when incorporated in starch bearing dough and batter products at normal commercial baking temperatures.

### BACKGROUND OF THE INVENTION

1. Field of the Invention

The present invention relates generally to a food additive and especially to a solid, powdered, highly functional starch-complexing and emulsifier agent that may be incorporated in a food product such as starch-bearing bread dough or batter at the temperature of an existing and typical dough preparation operation without pre-hydration of the emulsifier. In particular, the invention relates to a stable co-crystallized monoglyceride and a fatty acid lactylate salt emulsifier that may be prepared as a particulate powder that is adapted to be employed by the user in conventional dough and batter mixing applications without pre-hydration of the emulsifier. The co-crystallized compositions no longer exhibit the higher melting point of the monoglyceride; instead each unique co-crystalized composition has a new lower melting point specific for that composition. In addition, the co-crystallized compositions have been found to be highly effective in complexing starch at ambient temperatures whereas the pure monoglycerides require hydration at elevated temperatures for starch-complexing functionality.

2. Description of the Prior Art

Saturated monoglycerides such as distilled glycerol monostearate are known to be highly functional food emulsifiers that are widely used not only for emulsification, but also as starch-complexing agents, anti-staling compositions, and stabilizers in a variety of food products including bread, cakes, and other flour-based products, whipped toppings, sauces, and the like. Preferably, the distilled monoglyceride stearate is employed in hydrated form for increased functionality. In order for emulsifiers to improve the texture and stability of foods the emulsifier must first become associated with water. Monoglyceride food emulsifier compositions are generally prepared by melting the monoglyceride composition in heated water above its Krafft point, which for glycerol monostearate is about 60° C. The 60° C. Krafft point is where the monoglyceride begins to open up and allow water to penetrate. Therefore, distilled monoglycerides are not functional at the temperatures conventionally employed in the mixing of ingredients in the preparation of bakery products.

Furthermore, when the temperature of the water reaches about 80° C., a so-called mesophase (liquid-crystalline phase) forms, built up of multiple layers of monoglyceride molecules with highly mobile fatty acid chains separated by layers of water. After cooling, the fatty acid chains form a gel. In the gel, the emulsifier is crystallized in the α form. Because the gel phase is not stable, the gel ultimately transforms into crystalline platelets of monoglycerides in the β form, enclosing water. The opaque white monoglyceride paste, called a coagel, is known as the hydrated form of the monoglyceride in bakery literature.

In the gel form, the somewhat tacky monoglycerides are very effective at complexing the amylose fraction of starch, but involve a very complicated and difficult procedure for adding the monoglyceride paste to, for example, bread dough in a typical commercial bread production operation where dough processing is carried out at a temperature significantly below the Krafft point of the monoglyceride. In general, the distilled monoglyceride stearate paste has to be scooped manually from the packaging therefor and personnel are then required to climb to the top of the dough processor in order to deposit the monoglyceride material in the dough. Accordingly, presently available hydrated distilled monoglyceride stearate emulsifiers are not readily adapted for use by large-scale, automated bakeries or food processing plants.

Alternatively, distilled monoglycerides are commercially available as “dispersible” powders. Dispersibility of such products is improved by spray chilling mixtures of saturated and unsaturated distilled monoglycerides. Unsaturated monoglycerides are more hydrophilic than saturated monoglycerides and therefore do aid in the hydration of the mixtures at temperatures below the Krafft point. However, the unsaturated monoglycerides do not have starch-complexing functionality properties approaching that of saturated monoglycerides. Thus, although dispersible monoglycerides in powdered form are more convenient to use than the hydrated monoglycerides in paste form, the dispersible powdered products consisting of a mixture of saturated and unsaturated monoglycerides are not as functional or as effective in complexing of starch as is the case with the conventional hydrated forms of the monoglycerides.

In U.S. Pat. No. 4,684,526, the patentee describes the blend of lecithin with any one of a number of hydrophilic agents, including lactic acid esterified monoglyceride, succinic acid esterified monoglyceride, maleic acid esterified monoglyceride, or edible salts of stearyl lactate acid. However, the '526 patent does not describe incorporating sodium stearoyl-2-lactylate (SSL) or calcium stearoyl-2-lactylate (CSL) in a saturated monoglyceride at a temperature above the Krafft point of the monoglyceride and then cooling such combination while forming the emulsifier into a solid, readily dispersible form.

One of the fundamental properties of an emulsifier is the presence of both polar and non-polar moieties in its structure. Another property of an emulsifier is the ability to form a stable emulsion between water and oil. For food applications, the emulsifier desirably has the ability to form complexes with starch and protein. Other emulsifiers are ionic and impart special functionality to food products in certain applications. Although monoglycerides are examples of emulsifiers capable of forming an emulsion and complexing with starch, the lactylates such as SSL and CSL are unique as food emulsifiers in that they combine all of the above listed emulsification attributes in one product.

The stearic acid moiety of SSL and CSL participate in starch-complexing in a manner deemed to be very similar to the starch-complexing property of glycerol monostearate. It is believed that the stearic acid moiety is intercalated into the slightly non-polar helical starch structure resulting in an insoluble complex.

The Myvatex P-28K emulsifier of Quest International is described as being a combination of distilled monoglyceride and SSL for use in yeast-raised or other bakery goods.

### SUMMARY OF THE INVENTION

The present invention is a solid particulate food emulsifier preferably in powdered form that comprises the co-crystallized combination of a quantity of a starch-complexing saturated monoglyceride and an amount of a fatty acid hydrophilic lactylate salt. Fats are crystalline polymers with α,β, and β′ being the principal crystalline forms. Differential scanning calorimeter (DSC) analysis establishes that the co-crystalized combination is a different and combined material having a single DSC value as compared with conventional monoglyceride compositions, which exhibit a number of different and independent DSC values representative of the various crystalline forms of the monoglyceride.

Preferably, the monoglyceride has from about 12 to about 20 carbon atoms, and most preferably is a distilled glycerol monostearate. In the typical distilled monoglyceride composition contemplated in this invention, the monoglyceride content is about 94%. 90% of the 94% total monoglycerides comprises α monoglyceride, while the remaining 6% of the commercial grade monoglycerides comprises about 4% diglycerides and about 2% triglycerides. Therefore, as used herein, the terminology “saturated monoglycerides” is understood to mean a typical commercial monoglyceride composition as described above.

The preferred fatty acid lactylate salt has from about 12 to about 20 carbon atoms and most preferably is sodium stearoyl lactylate (SSL) or calcium stearoyl lactylate (CSL). The hydrophilic fatty acid lactylate salt is intimately incorporated into the starch-complexing saturated monoglyceride while the combination is preferably maintained at a temperature of from about 65° C. to about 150° C. Thereafter, the combination is cooled and formed into a series of discrete co-crystallized solid emulsifier particles having a melting point less than that of the monoglyceride, which is typically greater than about 70° C. that is determined using a conventional DSC. The DSC temperature is determined by placing two small pans in the instrument, one being empty while the other contains the sample undergoing evaluation. The magnitude of the difference, expressed as milliwatts per milligram, between the empty pan and the pan with the sample using a DSC, is referred to herein as a DSC defined melting point temperature.

The combination of monoglyceride and the fatty acid lactylate salt is thoroughly admixed while being heated to a temperature within the range of from about 65° C. to about 150° C., preferably to a temperature within the range of from about 85° C. to about 125° C., and most preferably from about 95° C. to about 115° C., before being cooled. The amount of monoglyceride present is from about 10% to about 90% of the quantity of monoglyceride, desirably is present in an amount of from about 15% to about 85% of the quantity of monoglycerde, preferably is present in an amount of from about 25% to about 75% of the quantity of monoglycerde, and most preferably is present in an amount from about 40% to about 60% of the quantity of monoglyceride. The monoglyceride is preferably commercial grade and therefore a 90% distilled monoglyceride

The homogeneous monoglyceride and fatty acid lactylate salt blend composition is cooled and formed into discrete co-crystallized emulsifier particles. The emulsifier composition is flaked while cooling, or the solid product formed is ground into a fine powder. Alternatively the emulsifier composition may be formed into a powder by spray chilling of the liquid blend. The solid powdered emulsifier additive may be conveniently added using existing pneumatic or mechanical delivery units to the dough or batter mixer forming a part of commercial baking equipment at existing normal mixing temperatures.

### BRIEF DESCRIPTION OF THE DRAWING

FIG. 1 is a graphical representation comparing the DSC defined melting points of the constituents of a dry mixture of 60% SSL and 40% distilled monoglycerides with the DSC defined melting point of a particulate co-crystallized emulsifier composition containing 60% SSL and 40% distilled monoglycerides.

FIG. 2 shows that even at levels of SSL as low as 10%, no melting point of distilled monoglyceride is observed. As the percentage of SSL in the co-crystallized emulsifier is increased the melting point continues to decrease.

### DETAILED DESCRIPTION OF THE PREFERRED EMBODIMENT

It has now been discovered that the functionality of dry saturated commercial grade monoglycerides such as monoglyceride stearate can be significantly improved without the necessity of preheating by co-melting a starch-complexing saturated monoglyceride with a substance such as a fatty acid lactylate salt before converting the combination to a powder. It has been found that a powdered emulsifier consisting of the co-crystallized combination of a monoglyceride with a hydrophilic substance such as a fatty acid lactylate salt, may be added to starch-bearing dough and batter formulations at a typical commercial bakery mixing temperature of about 70° F. to about 80° F. without pre-hydration of the composition being required. Thus, the composition is more convenient to use while the functionality of the emulsifier is essentially the same as the hydrated form. Especially suitable materials for blending with a monoglyceride such as glycerol monostearate are hydrophilic lactylate salt emulsifiers such as sodium stearoyl-2-lactylate and/or calcium stearoyl-2-lactylate. It has further been discovered that maximum functionality of monoglyceride in solid form is retained at varying levels of the hydrophilic agent. In particular, the percentage amount of the hydrophilic agent should be in the range of about 10% to about 90% relative to the quantity of monoglyceride. In the case of glycerol monostearate having SSL and/or CSL incorporated therewith, the amount of the lactylate agent should be from about 10% to about 90% relative to the quantity of monoglycerides, preferably from about 25% to about 75% of the lactylate agent relative to monoglyceride, and most preferably from about 40% to about 60% of the lactylate agent relative to monoglycerde. It is to be understood in this respect that the distilled monoglycerol stearate is preferably a commercial product that contains 95% monoglycerides while the remaining 5% is a mixture of about 4% diglycerides and approximately 1% triglycerides. Thus, the ratios set forth above are with respect to commercial monoglycerol stearate as described.

As used herein, the terminology “Krafft point” is the temperature at which the solubility of a surfactant such as a monoglyceride equals the Critical Micelle Concentration (CMC). A micelle is a build-up from polymeric molecules or ions and occurring in certain colloidal electrolytic solutions. There is a relatively small range of concentrations separating the limit below which virtually no micelles are detected and the limit above which virtually all additional surfactant molecules form micelles. The properties of a surfactant solution, if plotted against the concentration, shows the change at a different rate above and below this range. By extrapolating the loci of such a property above and below this range until they intersect, a value may be obtained known as the critical micellization concentration (CMC). Below the Krafft point, it is possible that even at the maximum solubility of a surfactant such as monoglyceride or lactylate emulsifier, the interface between the surfactant and water may not be saturated, and therefore micelles do not form. Above the Krafft point, micelles will form and as a result of their high solubility, there will be a dramatic increase in surfactant solubility. The Krafft value is therefore the point in a graph of solubility where a dramatic increase in surfactant solubility occurs. Because of the inherent complexity of making reliable Krafft point determinations, it is preferred that a differential scanning calorimeter be used to determine the peak milli-joules per milligram of a sample, in that the value obtained is representative of the average melting point of the composition.

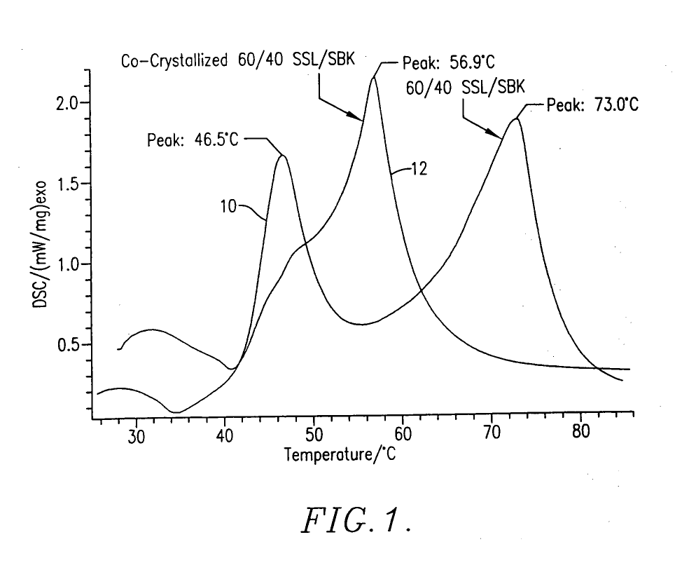

Tests conducted with a DSC to determine the DSC defined melting point of a dry blended formulation containing 60% SSL and 40% distilled monoglyceride stearate by weight, gave two separate peak values as indicated by the line 10 in FIG. 1, as compared with the single peak value obtained with a 60/40 ratio by weight of SSL and distilled monoglyceride stearate that were co-melted and then cooled under conditions forming a co-crystallized composition, as indicated by line 12 of FIG. 1. In the graph of FIG. 1, DSC represents energy changes relative to a control. Two pans are placed in a heating chamber, one of which is empty while the other contains the material that is being analyzed for temperature increase. The DSC is the difference in temperature change between the two pans.

It can be seen from the graphical representation of FIG. 1 that the dry blended mixture of 60% SSL and 40% distilled monoglyceride stearate were found to have independent DSC defined melting points of 46.5° C. for the SSL and 73° C. for the distilled monoglycerides. In contrast, the co-crystallized combination of 60% SSL and 40% distilled monoglyceride stearate by weight were found to have a single DSC defined melting point of 56.9° C. The single DSC defined melting point for the co-crystallized combination of SSL and distilled monoglyceride stearate confirmed that the structure of the co-melted formulation changed upon cooling, and are believed to have co-crystallized one with the other.

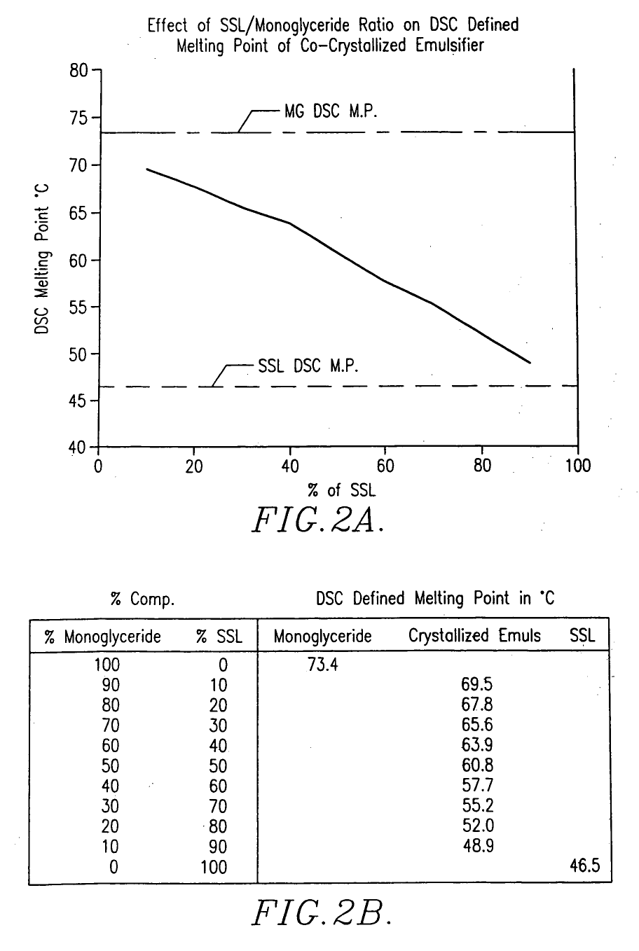

FIG. 2 is a graphical representation that each different combination of SSL and monoglyceride has a distinct melting point and therefore is a distinct material, whereas monoglyceride and SSL each have the same constant melting point regardless of the percentage of SSL or monoglyceride in a formulation.

In preferred formulations using the co-melted SSL and distilled monoglyceride stearate composition in powdered form, the amount of SSL is preferably about 0.375% SSL and 0.2 to about 0.25% distilled monoglyceride stearate on a baker's weight basis. Other preferred formulations may contain different ratios of SSL and the distilled monoglyceride stearate composition, so long as the amount of SSL does not exceed the approved level of 0.5% baker's weight.

Several methods may be employed to reduce the co-melted distilled monoglyceride stearate and SSL and/or CSL to a powdered form. The co-melted material can be spray chilled or solidified on a flaking apparatus, such as a chilled drum, and then the flakes ground into a powder of desired particle size by conventional milling apparatus thus producing a powdered product acceptable for use within the food processing industry.

### EXAMPLE

A test was conducted of white pan bread produced by a conventional sponge and dough process known to those skilled in the art. The variables were as follows:

| | | |
|---|---|---|
| no emulsifier control | volume 2950 cc | crumb firmness 272 g |
| 0.375% SSL + 1% GMS 90 | volume 3138 cc | crumb firmness 225.5 g |
| 0.625% of (70% SSL/30% | volume 3213 cc | crumb firmness 190 g |
| monoglyceride co-melted) | | |
| 0.625% of (70% SSL/30% | volume 3000 cc | crumb firmness 259.8 g |
| monoglyceride blended) | | |

Crumb firmness was measured by the TA-XT2 Texture Analyzer (Texture Technologies Corp.) according to methods known to those skilled in the art. Volume was measured by the rapeseed displacement—known to those skilled in the art. The results demonstrated a significantly improved functionality when SSL and monoglyceride were co-crystallized as opposed to being blended without co-melting and co-crystallization.

Commercial grade monoglycerides do not exert their dual functions as a starch-complexing and dispersing agent until the temperature of the monoglyceride composition is increased to at least the Krafft temperature of about 60° C. As described previously, the DSC defined temperature as used herein is a reasonable approximation of a Krafft temperature. The baking test set forth in the above example is one measure of starch-complexing. By baking bread with a conventional pre-hydrated monoglyceride emulsifier, and then baking bread with the co-crystallized combination of a starch-complexing saturated monoglyceride and a hydrophilic fatty acid lactylate salt, a determination can be made as to how soft the respective bread samples stay over time. Based on that criteria, it has been determined that the co-crystallized combination of a saturated monoglyceride and a fatty acid lactylate salt serves to maintain the softness of a baked product such as bread to a degree essentially equal to the monoglyceride that had been hydrated prior to incorporation with the bread dough.

After bread is baked, as it comes out of the oven the bread is very soft. However, unless a starch-complexing agent such as hydrated monoglycerides are included in the dough, the starch in the bread crystallizes at a relatively rapid rate and the bread quickly becomes firmer in no more than a day or two. Starch granules contain soluble linear amylose units and relatively insoluble branched amylopectin units. During baking of bread dough, the amylose units leak out of the starch granules while the amylopectin units are retained inside the granules. Right after baking, the amylose units associate with one another, causing the bread to be soft and pliable. However, over time, the amylose units associate and form crystals, resulting in the bread becoming firm and hard, not because of loss of water, but because of crystallization of the amylose units. Monoglycerides, when they become functional, become interspersed and sterically locked with the amylose units and thereby inhibit crystallization of the starch.

The co-melted and co-crystallized combination of saturated monoglycerides and hydrophilic fatty acid lactylate of this invention is functional as a starch-complexing agent and as an emulsifer to the same degree as conventional pre-hydrated monoglycerides.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A solid particulate starch-complexing and emulsifier agent that is adapted to be incorporated in starch-bearing food products such as dough and batter formulations at normal mixing temperatures, said emulsifier comprising:
the co-crystallized combination of a starch-complexing saturated monoglyceride having from about 12 to about 20 carbon atoms and an effective amount of a fatty acid lactylate salt having from about 12 to about 20 carbon atoms,
said monoglyceride and the fatty acid lactylate salt having been co-melted and blended to produce a homogeneous composition, and
the co-melted and blended composition having been cooled and solidified under conditions forming discrete co-crystallized stable emulsifier particles having a DSC defined melting point of no more than about 60° C.

2. An emulsifier as set forth in claim 1 wherein the combination of the monoglyceride and the fatty acid lactylate salt have been co-melted and blended at a temperature within the range of from about 65° C. to about 150° C. before cooling thereof and formation into said discrete solid co-crystallized emulsifier particles.

3. An emulsifier as set forth in claim 1 wherein the combination of the monoglyceride and the fatty acid lactylate salt have been co-melted and blended at a temperature within the range of from about 85° C. to about 125° C. before cooling thereof and formation into said discrete solid co-crystallized emulsifier particles.

4. An emulsifier as set forth in claim 1 wherein the combination of the monoglyceride and the fatty acid lactylate salt have been co-melted and blended at a temperature within the range of from about 95°C. to about 115°C. before cooling thereof and formation into said discrete solid co-crystallized emulsifier particles.

5. An emulsifier as set forth in claim 1 wherein said co-crystallized combination of the monoglyceride and the fatty acid lactylate salt is in powder form.

6. An emulsifier as set forth in claim 1 wherein said monoglyceride is glycerol monostearate.

7. An emulsifier as set forth in claim 1 wherein said fatty acid lactylate salt is sodium stearoyl-2-lactylate.

8. An emulsifier as set forth in claim 1 wherein said fatty acid lactylate salt is calcium stearoyl-2-lactylate.

9. An emulsifier as set forth in claim 1 wherein the amount of said fatty acid lactylate salt is from about 5% to about 95% of the quantity of monoglyceride.

10. An emulsifier as set forth in claim 1 wherein the amount of said fatty acid lactylate salt is from about 10% to about 90% of the quantity of monoglyceride.

11. An emulsifier as set forth in claim 1 wherein the amount of said fatty acid lactylate salt is from about 25% to about 75% of the quantity of monoglyceride.

12. An emulsifier as set forth in claim 1 wherein the amount of said fatty acid lactylate salt is from about 40% to about 60% of the quantity of monoglyceride.

13. A process for producing a solid particulate starch-complexing and emulsifier agent that is adapted to be incorporated in starch-bearing dough and batter formulations at conventional mixing temperatures, said process comprising
combining a quantity of a starch-complexing saturated monoglyceride having from about 12 to about 20 carbon atoms with an amount of a fatty acid lactylate salt having from about 12 to about 20 carbon atoms;
co-melting and blending the combination of monoglyceride and the fatty acid lactylate salt to produce a homogeneous composition; and
cooling and solidifying the blended composition under conditions forming discrete, stable, co-crystallized, particulate solid emulsifier particles having a DSC defined melting point of no more than about 60° C.

14. A process as set forth in claim 13 wherein is included the step of co-melting and blending the combination of the monoglyceride and said fatty acid lactylate salt at a temperature within the range of from about 65° C. to about 150° C. before cooling of the combination.

15. A process as set forth in claim 13 wherein is included the step of co-melting and blending the combination of the monoglyceride and said fatty acid lactylate salt at a temperature within the range of from about 85° C. to about 125° C. before cooling of the combination.

16. A process as set forth in claim 13 wherein is included the step of co-melting and blending the combination of the monoglyceride and said fatty acid lactylate salt at a temperature within the range of from about 95° C. to about 115° C. before cooling of the combination.

17. A process as set forth in claim 13 wherein is included the step of forming the combination into a co-crystallized powder during cooling thereof.

18. A process as set forth in claim 13 wherein said monoglyceride is glycerol monostearate.

19. A process as set forth in claim 13 wherein said fatty acid lactylate salt is sodium stearoyl-2-lactylate.

20. A process as set forth in claim 13 wherein said fatty acid lactylate salt is calcium stearoyl-2-lactylate.

21. A process as set forth in claim 13 wherein is included the step of providing an amount of said fatty acid lactylate salt that is from about 5% to about 95% of the quantity of the monoglyceride.

22. A process as set forth in claim 13 wherein is included the step of providing an amount of said fatty acid lactylate salt that is from about 10% to about 90% of the quantity of the monoglyceride.

23. A process as set forth in claim 13 wherein is included the step of providing an amount of said fatty acid lactylate salt that is from about 25% to about 75% of the quantity of the monoglyceride.

24. A process as set forth in claim 13 wherein is included the step of providing an amount of said fatty acid lactylate salt that is from about 40% to about 60% of the quantity of the monoglyceride.

25. A process as set forth in claim 13 wherein is included the step of forming the combination of monoglyceride and the fatty acid lactylate salt into a series of discrete flakes during cooling of the combination.

26. A process as set forth in claim 13 wherein is included the step of grinding the discrete particles to form a powder therefrom.
